(19) United States
(12) Patent Application Publication
(10) Pub. No.: US 2014/0281952 A1
(43) Pub. Date: Sep. 18, 2014

(54) INTERACTIVELY VIEWING MULTI DOCUMENTS ON DISPLAY SCREEN

(71) Applicant: Wei Zhang, Newtown, PA (US)

(72) Inventor: Wei Zhang, Newtown, PA (US)

(21) Appl. No.: 14/205,332

(22) Filed: Mar. 11, 2014

Related U.S. Application Data
(60) Provisional application No. 61/782,852, filed on Mar. 14, 2013.

(51) Int. Cl. G06F 17/21

(52) U.S. Cl. CPC G06F 17/212
USPC 715/273

(57) ABSTRACT

A computer implemented method for viewing multi document interactively involves viewing two or more documents concurrently displayed on display screen and bringing a content portion of one document into corresponding view region on display screen when a selectable link embedded in another document, which represents a reference to the content portion, is selected by user interface input acted thereupon. Each document is hosted by a browser engine to display on a display region on display screen. A browser engine host performs as a coordination and information center of the browser engines. When a selectable link is selected, the hosting browser engine submits a request containing identification of the link to the browser engine host. The browser engine host processes the request and, accordingly, direct the browser engine destined to act thereupon to bring the referred content into viewable area of corresponding display region.

### CROSS-REFERENCE TO RELATED APPLICATIONS

The present application claims the benefit of U.S. Provisional Application Ser. No. 61/782,852 filed by Wei Zhang on Mar. 14, 2013 and titled “Interactively viewing multi documents on display screen”, which is incorporated herein by reference.

### STATEMENT REGARDING FEDERALLY SPONSORED RESEARCH OR DEVELOPMENT

Not Applicable.

### FIELD OF THE INVENTION

The present invention generally relates to viewing document on display screen, specifically to viewing multi documents interactively on display screen driven by a computer implemented method that realizes content viewing across documents.

### BACKGROUND OF THE INVENTION

Electronic document is normally viewed by user on computer driven display screen. When content of electronic document is more than what display screen could possibly accommodate, the whole content of the document has to be scrolled across the viewable region of display screen through user interface interaction of user's input and computer program running behind on CPU and memory that turns user's input into content changes on the display. Such computer program providing viewing of electronic digital files on display screen is often referred as document browser or viewer. At one time, user is only able to view portion of the whole content that currently displayed. If one portion of the content refers to another portion of the content that locates far away on content layout, it is not possible to have both portions concurrently displayed on the viewing region on the display. To comprehend both portions, user often has to scroll the displayed content back and forth between the two portions. Thus, viewing experience is impaired and user could easily get tired and mentally discomforted by scrolling back and forth. For some types of documents, such as technical descriptive documents or patent documents, it often relies on combining meaning of written text and illustration of drawings to elaborate complex concept, principle, structure or process. Viewing those types of documents is sometimes a painful process for most readers, especially for new readers who are not very familiar to written structure of the documents. In order to comprehend the content, user must scroll the document back and forth to access the drawing while having to remember momentarily the involved written text portion or vice versus. This no only causes difficulty for user to comprehend the content, but also consumes extra time by scrolling back and forth.

One possible solution to ease the viewing difficult mentioned above is to embed a clickable link among descriptive texts, which, when clicked by user, opens a popup window to display the linked drawing or content. This scheme is often found useful for website browsing. However, it still presents drawback that detriments user's viewing experience. One drawback is, if each link opens its own popup window for displaying relevant content, user still faces difficult to organize and mange many popup window on display screen in order to quickly find corresponding popup window for his interested content. If several links share the same popup window to display relevant contents, user has to scroll up the descriptive texts to find previous link if he intends to view back previously viewed content on the popup window. Because of the difficult to organize many popup windows effectively without blocking each other, this solution has limited capability to improve user's viewing experience for document or content that contains references to other content or documents.

### BRIEF SUMMARY OF THE INVENTION

In accordance with the invention, a computer implemented method for viewing multi document interactively is disclosed in this disclosure. The method involves viewing two or more documents concurrently displayed on display screen and bringing a content portion of one document into corresponding view region on display screen when a selectable link embedded in another document, which represents a reference to the content portion, is selected by user interface input acted thereupon. For example of viewing two documents concurrently, the method starts with having both document respectively hosted by separate browser engines and displayed on separate view regions on the display. During user's viewing, if a location in the first document refers to a content portion of the second document, a selectable content control is presented at the location, indicating a selectable link to the content portion. To view the reference, user selects the selectable content control through user-interface input means, typically a computer mouse click thereon or a touch input thereon if touch panel is in use for user interface input. The browser engine, which hosts displaying of the first document, captures the action of the user input and processes the captured action to identify the selected content control and retrieve identification of the linked content portion. Then, the browser engine submits a request containing the identification information to a browser host engine, which acts as a coordination center for directing interactive operation between the two browser engines. The browser host engine processes the request to determine the action necessary to fulfill the request, prepares data for executing the action if needed, and sends a direction of response in accordance with the action to the browser engine that hosts displaying of the second document. Upon receiving the direction of response, the browser engine processes the direction of response and acts to bring the linked content portion of the second document into the view region thereof. So, results of user' input upon the selectable content control in view region of the first document causes the linked content portion showing up in the view region of the second document. To facilitate the browser engine to find the linked content portion, the document may contain a label that marks the presence of the linked content portion. The label embedded in the document may be hidden from viewing. The same process may be used vice versus for user to select a selectable content control in the second document to bring correspondingly linked content portion of the first document into view region associated with the first document. Under the teaching and merit of the example for viewing two documents, the method can be readily implemented for viewing more than two documents with cross-document content portion references among them. By implementing the method, user is able to view cross-linked content portions of multi documents interactively and, meanwhile, independently browse each document. Therefore, user's viewing experience on multi documents with cross-referred content portions is dramatically improved and comprehension on the cross-referred contents thereof is promoted.

In accordance with the invention, above description of summary is best effort to fulfill purpose or need of Brief Summary of Invention section and should not be used for purpose to reduce or be against merits of the invention as a whole. Furthermore, not to be limited by this summary section, all patentable rights embodied in or derived from the complete disclosure are reserved without prejudice.

### BRIEF DESCRIPTION OF THE SEVERAL VIEWS OF THE DRAWINGS

It should be understood that the brief description of the several views of the drawings is only for the purpose of presenting a concise reference to accompanying drawings and should not be inferred to have any suggestion to limit or reduce the scope of invention. Furthermore, the concepts and embodiments of the invention explicitly or implicitly shown in the drawings are only possibly understood accordingly by referring to following detailed descriptions upon illustrative showings of the drawings. For illustrative purpose, the drawings are not in scale. In the drawings:

FIG. 1 is a block diagram to illustratively show the work flow of the method of interactively viewing multi documents in accordance with the invention.

FIG. 2 is a flow chart to illustratively depict process of the method of interactively viewing multi documents in accordance with the invention.

FIGS. 3A, 3B and 3C are block diagrams respectively to illustrate one feasible implementation embodiment of the method of interactively viewing multi documents in accordance with the invention. FIG. 3A illustrates the implementation embodiment that data source (14) may be accessed through network connection (2) instead of through local storage media. FIG. 3B illustrates the implementation embodiment that has browser engine host (13) is located on a remote server (4) and communicates with browser engines (11 and 12), which locate on a local computer (3), through network connection (2). In the implementation embodiment, data source (14) is locally accessible by the browser engine host. FIG. 3C illustrates the implementation embodiment that has browser engine host (13) is located on remote server (5) and communicates with browser engines (11 and 12) locating on local computer (3) through network connection (2). The implementation embodiment has data source (14) located not locally to the server (5), but accessible through network connection.

FIG. 4 is a schematic drawing to illustratively show the user interface of one example of implementing the method in accordance with the invention to facilitate viewing patent or patent application related documents.

FIG. 5A, 5B, 5C and 5D are screen captured images of computer codes in .net C# language to demonstrate how the example, whose user interface is illustrated in FIG. 4, to achieve the functionalities that are useful for implementing the method of interactively viewing multi documents in accordance with the invention.

FIGS. 6A, 6B, and 6C are screen captured images of document data in html format that contain html tags for cross-document references and JavaScript function to support automatic content rolling, which are useful for the example in accordance with illustration of FIG. 4 and demonstrations of FIG. 5A-5D. FIG. 6A illustratively shows document data for specification of patent or patent application related documentation. FIG. 6B are exemplary portions of the specification document data that show embedded tagged links for cross-document references. FIG. 6C illustratively shows document data for specification of patent or patent application related documentation.

FIG. 7 is a flowchart to illustrate process of one interactively viewing cycle for the example in accordance with illustration of FIG. 4 and demonstrations of FIG. 5A-5D.

FIG. 8 is schematic drawings of the user interface views, in accordance with illustration of FIG. 4 and demonstrations of FIG. 5A-5D, that illustrates the interactively viewing cycle from aspect of display screen change, which starts with a user input action to select a selectable figure reference (82) on specification view pane (41) and ends with the drawing (83) of the referred figure become viewable on drawing view pane (42).

FIG. 9 is schematic drawings of the user interface views, in accordance with illustration of FIG. 4 and demonstrations of FIG. 5A-5D, that further illustrates the interactively viewing cycle from aspect of display screen change, which starts with a user input action to select a selectable figure reference (92) on specification view pane (41) and ends with the drawing (93) of the referred figure become viewable on drawing view pane (42).

FIG. 10 is schematic drawings of the user interface views, in accordance with illustration of FIG. 4 and demonstrations of FIG. 5A-5D, that illustrates the interactively viewing cycle from aspect of display screen change, which starts with a user input action to select a selectable reference (102) on drawing view pane (42) and ends with the referred content portion (103) of specification document (45) scrolled to top of specification view pane (42) and become viewable immediately.

FIG. 11 is a schematic drawing of the user interface views, in accordance with illustration of FIG. 4 and demonstrations of FIG. 5A-5D, that illustrates functionality of a reference indexed pane (43), which starts with a user input action to select a selectable figure reference (111) under tree-view root of Figures in the references indexed pane and ends with the drawing (112) of the referred figure become viewable on drawing view pane (42).

FIG. 12 is a schematic drawing of the user interface views, in accordance with illustration of FIG. 4 and demonstrations of FIG. 5A-5D, that further illustrates functionality of the reference indexed pane (43), which starts with a user input action to select Claims reference (121) under tree-view root of Sections in the references indexed pane and ends with the claims portion (122) of the specification scrolled to top of specification view pane (41) and become viewable immediately.

FIG. 13 is a schematic drawing of the user interface views, in accordance with illustration of FIG. 4 and demonstrations of FIG. 5A-5D, that illustrates usefulness of showing classification definition in a tooltip window 132 when mouse cursor (131) is hovering on the classification element under tree-view root of Classifications in the reference indexed pane (43).

FIG. 14 is a schematic drawing of the user interface views, in accordance with illustration of FIG. 4 and demonstrations of FIG. 5A-5D, that illustrates usefulness of showing figure caption in a tooltip window 142 when mouse cursor (141) is hovering on the figure element under tree-view root of Figures in the reference indexed pane (43).

### DETAILED DESCRIPTION

For terminology throughput this disclosure, term “Browser Engine” is a computer program module made of CPU executable codes that provide necessary functions to display at least portion of an electronic document on display screen and browse the full content by scrolling viewed portion along the full content through user interface input. Typical example of the browser engine is Web Browser to browser content of webpage, for example, Microsoft Internet Explorer, Firefox Web Browser, or Google Chrome Web Browser. Term “Browser Engine Host” is a computer program module made of CPU executable codes that acts as a coordination and information center to communicate with hosted browser engines and direct interactive responses among them. Term “Display Region” is an area on display screen that is used for displaying content of document hosted by browser engine. In windows based operation system, display region may refer to a window showed up in display screen. Term “Data Source” refers to source where needed information may be retrieved to support operation of the method disclosed therein. It may be a local storage media, such as hard drive, flash drive, or memory resided virtual drive, or a network accessible data server. Term “Display Screen” refers to viewable screen surface of a display or combined screen surfaces of a number of displays that are collectively in use for viewing documents.

In accordance with the invention, the method for viewing multi document interactively is understood better by referring to the illustrative teaching of FIG. 1. According the block diagram of FIG. 1, computer driven display 1 has two documents 16 and 18 displayed concurrently on two display regions 15 and 17, each of which accommodates viewing of one document. Due to limited size of the display region, only portion of content of accommodated document may be viewable at one time. Assuming the two documents are content related each other, it often requires to refer to a content portion of one document when comprehending one portion of the other document. Displaying and browsing the document on its corresponding display region is supported by a browser engine, which is a program module executing on CPU and memory of the computer driving the display operation. The browser engine provides functions to display content of the hosted document and allows user to browse full content of the hosted document through user interface inputs. According to the illustration, displaying and browsing document 16 on display region 15 is supported by a browser engine 11. Displaying and browsing document 18 on display region 17 is supported by a browser engine 12. Interaction between browser engines 11 and 12 is directed by a browser engine host 13. Browser engine host 13 is a program module made of CPU executable codes that communicates with hosted browser engines and processes interaction request submitted by one browser engine and directs interactive response of another browser engine according to processing decision of the interaction request. From the illustration, it is recognizable that browser engine host 13 performs as communication and coordination center for all host browser engines, which are browser engine 11 and 12 in the illustration. In real implementation, browser engine host may host more than two browser engines and support interactive responses among them. Depending upon needs of operation, browser engine host 13 may retrieve needed data information from data source 14. The data information retrieved from data source 14 may be used for own operation of the browser engine host or provided to hosted browser engine for completing directed response. The operational process of the method of interactively viewing multi document may be understood more thoroughly by referring to the flowchart of FIG. 2. From collective view, browser engines 11 and 12, browser engine host 13 and data source 14 are executed on computer system 10, which may be a single computer or a cluster of computers connected and communicated through network. To implement the process of the method, at starting, each document is loaded and hosted by one browser engine and, then, displayed in corresponding display region on display screen. The illustration of flowchart of FIG. 2 takes example of viewing two documents, but the teaching spirit and merit are readily applicable for viewing more than two document. Referring to step 21 of the flowchart of FIG. 2, following start step 20, a first document is hosted by browser engine 11 to display portion of its content on display region 15, and, a second document is hosted by browser engine 12 to display portion of its content on display region 17. The two documents contain references that refer to content portions of the other document. The references are display on display regions as selectable content control, which may be selected by user through user interface input means. Depending on capability of the display and the computer driving the display, the input means may be a computer mouse click, a keyboard input, or a touch input if touch panel display is in use. When use selects one of the selectable content controls, the browser engine hosting the document is notified to capture the action for processing. After loading the documents for displaying, user can start to browse the documents through user interface enabled by the browser engine. When user input select a selectable content control in display region 15, which represents a reference to a content portion of the second document, an interactively viewing cycle is invoked thereby. The interactively viewing cycle is illustrative shown from step 22 to step 25. Referring to step 22, when a selectable content control in display region 15, which represents a reference link to a content portion of the second document, is selected by user input means, the interactively viewing cycle starts. Following the user input selection, referring to step 23, browser engine 11 hosting the first document captures the user input event and identify the selected content control to obtain identification of the reference link. From the identification, browser engine 11 is able to decide whether the captured input event is for its own action or for an interactive action of the other browser engine. It is emphasized that, here, browser engine 11 doesn't need to know which browser engine should handle the interactive action and how the other browser engine to react. It only needs to tell whether the event triggered action should be handed by its own or forwarded to the browser engine host for further processing. After browser engine 11 determines the captured input event is for an interactive action, it submits a request containing the identification of the reference link, which in turn refers to a specific content portion of the second document, to browser engine host 13. Referring to step 24, upon receiving the request, browser engine host 13 processes the request. From the processing of the request, browser engine host 13 retrieves the identification of the reference link. From the identification information, browser engine host 13 is able to decide which browser engine should be directed to fulfill the request. Then, the browser engine host sends a direction of response, which contains identification of the referred content for the reference link and, if needed, additional information or data, to browser engine 12 for executing the interactive action. Referring step 25, browser engine 12 processes the received direction of response to retrieve at least identification of the referred content for the document hosted thereby. If additional information or data is provided with the direction of response, browser engine 12 examines the information or data in order to executing corresponding response. If it is found that more information or data is needed, browser engine 12 may submit request to browser engine host 13 to get the information or data. The additional information may comprise location information on display screen where the referred content portion is to be placed. After processing the direction of response, browser engine 12 executes necessary codes to bring the content portion identified by the identification into viewable area of display region 17. The position in the viewable area where the referred content portion is placed may be predetermined at a special location of the display region, or determined according to nature of the referred content portion. It is recognized that the interactively viewing cycle may go vice versus way that is invoked by user's selection of a selectable content control in display region 17, which represents a reference to a content portion of the first document, and finished with the referred content portion of the first document appearing in viewable area of display region 15. After the cycle steps complete, user continues browsing the documents. If user selects again a selectable content control representing a reference to a content portion of the other document, the interactively viewing cycle repeats again to bring the referred content portion into viewable area of the corresponding display region.

In accordance with the invention, FIGS. 3A, 3B and 3C gives several system level implementation examples of the method of interactively viewing multi documents. Referring to illustratively showing of FIG. 3A, browser engine host 13 and its hosted browser engines 11 and 12 are running on a local computer 3, which has display 1 connected therewith for displaying user interfaces. In the example, if needed, data source 14 is accessible by browser engine host through network 2. Network 2 may be a local network or internet. Referring to illustratively showing of FIG. 3B, browser engine host 13 is running on a server 4 and browser engines 11 and 12 are running on local computer 3. Browser engine host 13 communicates with browser engines 11 and 12 through network 2. Data source 14 may be a local storage of server 4 or attached to server 4 through local network (not shown) on the server side. Referring to illustratively showing of FIG. 3C, browser engine host 13 is running on a server 5 and browser engines 11 and 12 running on local computer 3, which are connected through network 2. In this example, data source 14 is placed separately and accessible through network 2. This example is suitable for situation that document contents themselves or their referred contents are located on a data server accessible through network connection. It is obvious that code level implementation for browser engine host and browser engine will vary according to the system implementation configuration. But, it is within normal practice scope and effort of skilled artisan in related programming technologies to achieve that by following the teaching and merits disclosed in this disclosure. It is recognized that these illustrated examples are presented to enlighten system level implementations of the method in accordance with the invention. So, these examples should not be viewed as only possible examples of the implementations.

In accordance with the invention, an application that implements the method of interactively viewing multi document is provided to promote comprehension and appreciation of the teaching and merits thereof. The application is to improve viewing experience of reading patent or patent application documents. For convenience, following will use patent documents to represent both patent document and patent applicable document since they have the almost same format and are essentially the same. Patent documentation primarily consists of two parts: specification and drawing. When reading a complete patent documentation in one file, reader often has to scroll pages back and forth to view drawing pages while reading the written description having the drawings referred. This has been very tedious and time-wasting for reader. The application disclosed herein, by implementing the method in accordance with the invention, allows user to browse specification document and drawing document of patent documentation independently and interactively, thus, giving user a convenient way to examine and comprehend the patent documentation. In the application, patent documentation is primarily made of a patent document and a drawing document, each of which is formatted appropriately to support the intended use. It is recognized that the patent document or the drawing document might not have to be in one electronic file and might be dispersed into multi electronic files but still browsed as a whole document. FIGS. 4 to 14 illustrate the important features of the application. Among these figures, FIG. 4 presents an illustrative view of the user interface of the application. FIG. 5A, 5B, 5C and 5D gives highlighted code examples to illustrate how core functions of the browser engine and the browser engine host are realized. FIGS. 6A, 6B, and 6C are html format data to illustrate how specification document and drawing document are constructed to support the interactively viewing. FIG. 7 presents a flowchart to illustrate the interactively viewing cycle in context of the application. FIG. 8 gives schematic drawing views about what user will see on the user interface when an interactively viewing cycle starting with clicking a figure reference on specification view pane and finishing with the referred figure becoming immediately viewable on drawing view pane. FIG. 9 is another illustration example similar as the illustration of FIG. 8. FIG. 10 gives illustration example in a vice versus way from the illustrations of FIGS. 8 and 9, which illustrates an interactively viewing cycle starting with clicking a usage reference of figure on drawing view pane and finishing with the usage reference location of the specification document appearing at top line of specification view pane. This enables user currently viewing a figure on drawing view page to quickly find out the descriptive portions regarding the figure in specification. FIGS. 11 to 12 are some additional features offered in the application to enhance viewing and comprehending patent documentations. Following paragraphs describe the application in more details.

Referring to the drawing of FIG. 4, user interface of the application has two primary view panes, specification view pane 41 and drawing view pane 42, occupying most area of host window 40. The user interface further comprises a header bar 49, a status bar 44, and, a references indexed pane 43. Host window 40 has a title bar 48 and common window control buttons at its upper-right corner. When a patent documentation is loaded into the user interface, specification view pane 41, acting as one of the display regions, hosts displaying content of specification document 45, and drawing view pane 42, acting as the other one of the display regions, hosts displaying drawings of drawing document 46. Title bar 48 is used to display patent number and title of patent documentation. Header bar 49 is display application oriented source information, which, in the case, is the entity from which the patent documentations is chosen to be opened for viewing. The user interface also contains an application oriented feature, status selection 47, which allows user to mark the patent documentation with different status for notification purpose and future use.

Following code examples are based on .NET C# language and WPF (Windows Presentation Foundation) technology. FIG. 5A presents screen captured image of XAML (Extensible Application Markup Language) codes for WPF application, which illustrates code level markup structure of the user interface of the application. Referring to FIG. 5A, a root element 50 renders host window 40. Among the elements contained inside root element 50, an elements 51 renders specification view pane 41 and provide support for displaying and browsing specification document in the pane. An element 52 renders drawing view pane 42 and provide support for displaying and browsing specification document in the pane. Element 51 and 52 are WPF WebBrowser class objects, which provides core functionality similar as using Internet Explorer to browse website document. In the application, both specification document and drawing document are HTML (Hyper Text Markup Language) document, thus operable by the WebBrowser elements. FIG. 5B presents screen captures images of C# codes that handles navigating event of the WebBrowser elements. In source code files, the C# code is located in code-behind file of the xaml codes and is compiled together with xaml codes to form one class object for execution. Referring to FIG. 5B, function 53 performs event handling of navigating event of the WebBrowser elements. When a clickable link in html document is clicked through user interface, operating system invokes an event to call function 53 to handle the event first. If the event is completed handled by the function, WebBrowser element will not further process the event anymore. Otherwise, after that, WebBrowser element will continue to process the event. This difference is decided by setting “Cancel’ property of event object TRUE. So, by setting “Cancel’ property of event object TRUE, function 53 will take over the event handling completely. Inside codes of function 53, URL (Uniform Resource Locator) value of the event, which contains identification information of the clicked link, is retrieved and passed to a function 54 for further processing. Function 54 takes the URL value and retrieves identification of the clicked link from the URL value. Then, function 54 passes the identification information to a function 55 for further processing. Codes of function 55 is presented in the screen captured image of FIG. 5C. Referring to FIG. 5C, function 55 processes the identification information to generate appropriate action request for dispatching to function 56, which is in charge of dispatching action request to corresponding WebBrowse element for execution. Codes of function 56 is presented in the screen captured image of FIG. 5D. Referring to FIG. 5D, function 56 processes the action code passed in and determine which WebBrowser element should be sent with the action code for execution. If the action code is for response on specification document, WebBrowser element 51 is the target to send the action code. As illustrated in the drawing, in this case, a function 57 is called as the result for executing the intended interactive action. If the action code is for response on drawing document, WebBrowser element 52 is the target to send the action code. As illustrated in the drawing, in this case, a function 58 is called as the result for executing the intended interactive action. Function 57 or 58 invokes a script function named “RollToParagraph” and passes to it the action code, which indicates where to roll the displayed content. WebBrower element 51 or 52 respectively executes the invocation and scroll the referred content portion indicated by the action code into specific location on specification view pane. Function 56 is also used to support internal navigation among the drawings of drawing document. For such case, a function 59 is called to execute the desired function. This internal navigation is irrelevant to the method of interactively viewing multi documents and is provided to help solve the problem of limited maximum number of drawings allowed to concurrently open in WebBrowser class object. As a summary for above descriptions about these code examples, WebBrowser 51 or 52 with support of function 53 and 54 to handle navigating event constitutes the browser engine (11 or 12) as described above. Collective effort of function 55 and 56, which processes the action request passed from function 54 and dispatch corresponding action code to WebBrowser 51 or 52, constitutes the browser engine host (13) as described above.

As described above, specification document and drawing document are in HTML format, which is very suitable to be hosted by WebBrowser class object. To support interactive viewing between the two documents, both documents contains labels to referred content portions and clickable links to represent referred content portions. In a word, the labels are used by WebBroswer to find location of referred content portion, and clickable links are used for use to select in order to interactively view specific referred content portion. Html code samples presented in screen captured images in FIGS. 6A, 6B, and 6C give examples of the labels and the clickable links. FIGS. 6A and 6B present html code samples for specification document. FIG. 6C presents html code sample for drawing document. Reffering to FIG. 6A and FIG. 6C, each html code sample of specification document or drawing document has a JavaScript function 61 with function name “RollToParagraph”, which, when called with a label parameter passed in, causes hosted WebBrowser to find the content portion in accordance with the label and bring the found content portion into specific location on viewable area of its view pane. In drawings of FIGS. 6A and 6B, code examples for labels are given numeral 62, which is a <span>element of HTML with “id” attribute assigned with value for labeling, such as “SECT0001”, “SECT0002” and so on. Each label corresponds to one content portion in specification document. For example, “SECT0001” corresponds to “Abstract” portion, and “SECT0003” corresponds to “Claims” portion. In the drawing of FIG. 6B, code portions 60A, 60B and 60C give better enlarged view of html code samples for some portions of specification document. Among them, code portion 60A covers part of content from “Description” section to “DETAILED DESCRIPTION” section, and, code portions 60B and 60C gives parts of content of “DETAILED DESCRIPTION” section. In these code samples, numeral 62 indicates code samples for labels. Numeral 63 indicates code samples for clickable links, which is a html <a> element with “id” attribute assigned with labeling and “href” attribute assigned with identification information of referred content portion for which the tag is linked. When the <a> element is clicked, the value in “href” attribute is included in URL property of navigating event and passed by hosting WebBrowser to navigating event handler. As described above, the URL value is processed accordingly to complete the interactively viewing cycle if the clickable link represents a reference to content portion of the other document. In the drawing of FIG. 6C, each drawing page of drawing document is contained in a code block similar as code block 64. Code block 64 is for drawing page 1, which, in this documentation, corresponds to FIG. 1. Referring to codes inside code block 64, code sample 65 is a html <img> element that embeds the image file of drawing page 1 through its “src” attributes. The <img> element also has “id” attributes assigned with labeling “DRAWING0001”, which allows the hosting WebBrowser to find location of the content in order to bring this figure into viewable area. Code block 64 further has caption 65 of the figure shown below the image of the figure, which give viewer additional convenience to read brief information about the figure. Code block 54 further has reference links 63 below the caption, which is shown under the image of the figure and allows viewer to quickly find out reference location in specification document that refers to the figure. Each reference link 63 corresponds to one reference location for the figure in specification document. Block code 64 includes four reference links 63 because there are four locations in specification document that are found to refer to FIG. 1. Reference link 63 is made of html <a> element with “href” attributes containing identification for the reference location in specification document. When displayed by hosting WebBrowser, it renders a clickable line on display screen. When clicked by user, it invokes an interactively viewing cycle to bring the reference location to top line of specification view pane 41. With this capability, it no longer requires viewer to scroll up and down in specification view pane 41 in order to find where the figure is referred.

FIG. 7 illustratively shows work flow of the interactively viewing cycle in accordance with codes illustrated in FIG. 5A-5D and FIG. 6A-6C. When viewer clicks a clickable link on either specification view pane 41 or drawing view pane 42, referring to step 71, the first WebBrowser catches the navigating event and hands over the navigating event to function 53 to handle. Function 53 in conjunction with function 54 analyze URL value if the navigating event to retrieve identification of the reference to which the clicked link is referred. Then, referring to step 72, a request containing the identification of the reference is passed to function 55 for further processing. Function 55 in conjunction with function 56 perform role of the browser engine host. Referring to step 73, function 55 processes the request in accordance with the identification of the reference and pass corresponding action code to function 56. Referring to step 74, function 56 directs the second WebBrowser to response in accordance with the action code. Referring to step 75, the second WebBrowser executes the JavaScript function invoked accordingly by function 56 to bring the content portion in accordance with the action code into predetermined location in viewable area of view pane.

FIGS. 8, 9 and 10 give illustratively examples about what change on user interface viewer will observe for an interactively viewing cycle. According to FIG. 8, viewer initially observes the figure no. 1 highlighted by numeral 81 in drawing view pane 42. When viewer clicks a clickable link 82 referring to figure no. 6 under section of “BRIEF DESCRIPTION OF THE DRAWINGS” on specification view pane 41, drawing page shown visible on drawing view pane 42 automatically becomes the drawing page of figure no. 6. Depending on execution speed of the computer, the time delay between action of clicking and show-up of the figure may be unnoticeable, thus giving viewer a feeling that the drawing view pane immediately shows the figure for viewing. FIG. 9 gives another illustrative example similar as FIG. 8. According to FIG. 9, viewer initially observes the figure no. 1 highlighted by numeral 91 in drawing view pane 42. When viewer clicks a clickable link 92 referring to figure no. 3 under section of “DETAILED DESCRIPTION” on specification view pane 41, drawing page shown visible on drawing view pane 42 automatically becomes the drawing page of figure no. 3. FIG. 10 gives an illustrative example in vice-versus way. According to FIG. 10, viewer initially observes the figure no. 6 highlighted by numeral 101 in drawing view pane 42. Under caption line 105, there are two clickable links 104 and 102, each of which corresponds to one reference location in specification document where the figure is referred. When viewer clicks clickable link 102, the second reference location referring to figure no. 6, which is highlighted by numeral 103, is immediately brought to top line of specification view pane 41. From viewer's point of view, when he wants to know how figure no. 6 is used in descriptive text of specification, just clicking the reference link under the figure will immediately present the text portion of specification where the figure is referred.

The user interface of the application has additional features, accordingly shown in drawings of FIGS. 11, 12, 13 and 14, to further enhance user's viewing experience on patent documentation. FIGS. 11 and 12 illustratively show functionalities of references indexed pane 43. References indexed pane 43 are a collection of some significant labels in specification document and drawing document, presented in tree-view form and categorized under a variety of root elements. These information presented provides a central view of significant components of the patent documentation and a one-click approach to access corresponding contents in specification document and drawing document. Among them, tree-view root element “Sections” collects major sections of specification documents, for example abstract, claims, brief description of the drawings, and so on. Tree-view root element “Figures” collects references for figures, and, tree-view root “Classifications” collects US classes to which the patent documentation is classified. FIG. 11 illustrates one-click access to drawing of figure through the references indexed pane. Referring to illustration of the drawing of FIG. 11, a mouse click on figure element 111 for figure no. 5 under root element “Figures” causes the WebBrowser hosting drawing document to bring the drawing page corresponding to figure no. 5, highlighted by numeral 112, into viewable area of drawing view pane 42. FIG. 12 illustrates one-click access to section of specification through the references indexed pane. Referring to illustration of the drawing of FIG. 12, a mouse click on section element 121 for claims under root element “Sections” causes the WebBrowser hosting specification document to bring the “Claims” section of specification document, highlighted by numeral 122, to top of specification view pane 41. Sometimes, viewer may want to refer to classification to gain more understanding on how the patent documentation should be related to other patent documentation. FIG. 13 illustrates quick access to class definition. Referring to illustration of the drawing of FIG. 13, class definition becomes readily available for viewing in a Tooltip window 132 when mouse cursor 131 hovers over a class number element under tree-view root element “Classifications”. FIG. 14 illustrates quick access to caption of figures. Referring to illustration of the drawing of FIG. 14, when mouse cursor 141 hovers over a figure element under tree-view root element “Figures”, caption of the figure is given in a Tooltip window 142 for viewing. It is to be recognized that, in windows based operation system, tooltip window is designed to show up when mouse cursor is on a window element and disappear when mouse cursor moves away. It is believed that using tooltip window to present the caption and class definition provides viewer a view-on-fly viewing experience to access these useful information.

It should be understood that embodiments disclosed are only a few examples of possible implementations of the invention disclosed in the disclosure and their teachings may be used by ordinary skilled in related art to modify the embodiments or derive from the embodiments to form embodiment appearing not similar as the embodiments but still utilizing true merit and teaching spirit of the invention. Therefore, if any, the modification or derivation is still within the scope of the invention and all related rights are reserved.

I claim:

1. A computer implemented method comprising:
displaying content of a first document by a first browser engine in a first display region of a display surface and content of a second document by a second browser engine in a second display region on the display surface;
selecting a selectable content control, which belongs to said first document and represents a reference link to a content portion of said second document, on said first display region by computer input means;
retrieving an identification of said content portion by said first browser engine by capturing and processing an event generated by said selecting;
submitting a request comprising said identification by said first browser engine to a browser engine host acting as coordinator of said first browser engine and said second browser engine;
processing said request by said browser engine host to determine a direction of response in accordance with said request for fulfilling said request;
sending said direction of response by said browser engine host to said second browser engine; and,
bringing said content portion to viewable area of said second display region by said second browser engine, in accordance with said direction of response.

2. The computer implemented method in accordance with claim 1 further comprising a step of repeating steps from said selecting to said bringing.

3. The computer implemented method in accordance with claim 1 wherein the step of said processing said request further comprises a step of obtaining data needed for determining said direction of response from a data source.

4. The computer implemented method in accordance with claim 3 wherein said data source is accessed through network.

5. The computer implemented method in accordance with claim 1 wherein said first browser engine and said second browser engine are located on a local computer and said browser engine host is located on a remote computer communicating with said local computer through network.

6. The computer implemented method in accordance with claim 1 wherein said first browser engine, said second browser engine and said browser engine host are located on the same computer.

7. The computer implemented method in accordance with claim 1 further comprising steps of:
selecting a second selectable content control, which belongs to said second document and represents a reference link to a second content portion of said first document, on said second display region by computer input means;
retrieving an identification of said second content portion by said second browser engine by capturing and processing a second event generated by said selecting a second selectable content control;
submitting a second request comprising said identification of said second content portion by said second browser engine to said browser engine host;
processing said second request by said browser engine host to determine a second direction of response in accordance with said second request for fulfilling said second request;
sending said second direction of response by said browser engine host to said first browser engine; and,
bringing said second content portion to viewable area of said first display region by said first browser engine, in accordance with said second direction of response.

8. The computer implemented method in accordance with claim 7 further comprising a step of repeating steps from said selecting a second selectable content control to said bringing said second content portion.

9. A non-transitory computer-readable medium having sequences of instructions stored thereon, the sequences of instructions includes instructions which, when executed by a computer, causes the computer to perform operations comprising the steps of:
displaying content of a first document by a first browser engine in a first display region of a display surface and content of a second document by a second browser engine in a second display region on the display surface;
selecting a selectable content control, which belongs to said first document and represents a reference link to a content portion of said second document, on said first display region by computer input means;
retrieving an identification of said content portion by said first browser engine by capturing and processing an event generated by said selecting;
submitting a request comprising said identification by said first browser engine to a browser engine host acting as coordinator of said first browser engine and said second browser engine;
processing said request by said browser engine host to determine a direction of response in accordance with said request for fulfilling said request;
sending said direction of response by said browser engine host to said second browser engine; and,
bringing said content portion to viewable area of said second display region by said second browser engine, in accordance with said direction of response.

10. An user interface for viewing patent documentation comprising a specification document and a drawing document, comprising:
a specification view pane for browsing the specification document; and,
a drawing view pane for browsing the drawing document; wherein, said specification view pane is next to said drawing view pane, said specification view pane and said drawing view pane substantially occupy internal area of the user interface, and, in operation, an user input on a selectable content control of either one of said specification document and said drawing document, which represents a reference to a content portion of the other document, causes said content portion to automatically appear for viewing on the corresponding view pane.
